(19) United States
(12) Patent Application Publication
(10) Pub. No.: US 2025/0328596 A1
(43) Pub. Date: Oct. 23, 2025

(54) PROVIDING LINKS AND ASSOCIATED GLIMPSE PREVIEWS OF CONTENT ON A WORKSPACE

(71) Applicant: Notion Labs, Inc., San Francisco, CA (US)

(72) Inventors: Shahan Ahmed Khan, San Francisco, CA (US); Tyler Jeffrey Beauchamp, San Francisco, CA (US)

(21) Appl. No.: 18/642,245

(22) Filed: Apr. 22, 2024

(51) Int. Cl. G06F 16/957; G06F 16/955

(52) U.S. Cl. CPC G06F 16/957; G06F 16/955

(57) ABSTRACT

A method for providing a link and associated preview of content on a workspace includes causing display of a link to a second page of the workspace on a first page of the workspace. The second page embeds multiple blocks as in-page objects. The method includes preselecting a subset of the multiple blocks to include in a preview of the second page prior to runtime of the display of the link to the second page in the first page. The subset of the multiple blocks is preselected from among the multiple blocks based on content of a respective block or a location of the respective block on the second page. In response to an input the method can include causing display of the preview of the subset of the multiple blocks from the second page while displaying the link on the first page.

### BACKGROUND

Workspaces (e.g., digital workspaces) refer to environments that assemble tools and platforms that allow users to work, communicate, and produce work products together. Workspaces can be desktop or web-based applications that allow multiple users to share and access the workspaces in a variety of manners. Workspaces can include compilations of electronic documents that can be organized within the workspace.

A workspace document can include clickable links to content that is outside the workspace document. Such links can be for accessing other documents or content within the workspace or for accessing content that is outside the workspace. Using links in a workspace can be useful for providing additional context and supportive materials while keeping a length of a document short.

### BRIEF DESCRIPTION OF THE DRAWINGS

Reference will now be made, by way of example, to the accompanying drawings, which show example implementations of the present application, and in which:

FIG. 1 is a block diagram illustrating a platform, which may be used to implement examples of the present disclosure.

FIG. 2 is a block diagram of a transformer neural network, which may be used in examples of the present disclosure.

FIG. 3 is a block diagram illustrating a hierarchical organization of pages in a workspace.

FIGS. 4A through 4M are exemplary views of a workspace user interface for providing a link and an associated preview of content.

FIG. 5 is a flow diagram illustrating processes for providing a link and associated preview including summary of content on a workspace.

FIG. 6 is a flow diagram illustrating processes for providing a link and associated preview including a glimpse of content on a workspace.

FIG. 7 is a block diagram that illustrates an example of a computer system in which at least some operations described herein can be implemented.

The technologies described herein will become more apparent to those skilled in the art by studying the Detailed Description in conjunction with the drawings. Implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The present technology provides for methods and systems for providing links and link previews on a workspace. A link can be associated with a preview to provide a visual and/or textual representation associated with the content accessible via the link. The preview can help users to decide whether to click on the link or not by providing users with an indication of what to expect from the linked content. The previews can be especially useful for preventing non-necessary clicks to open content that is not useful or interesting to the user. There is, however, a need for methods to provide link previews with accurate and adequate representation of the content in order to enable efficient review of the content.

In particular, one aspect of the present technology can utilize content regenerated by artificial intelligence (AI) in the link previews. Some pages of a workspace include in-page objects (blocks) with AI-associated features. A page can include, for example, an AI-associated block that is associated with instructions to generate, using a generative AI system, a textual summary of all or part of the content on the page and displaying the textual summary in the block. In such instances, the link preview for such page can include a regenerated textual summary created by the AI system.

In one example, a method for providing a link and associated preview of content on a workspace includes causing, on a first page of the workspace, display of a link to a second page of the workspace. The first and second pages can be blocks of the workspace. The link can be embedded as an in-page object on the first page, and the second page can embed multiple blocks as in-page objects. Each block can include multiple properties that are defined by a block type of the respective block. The method can include regenerating a textual summary of the second page by using a generative AI system prior to runtime of the display of the link to the second page in the first page. The textual summary can be stored as a summary property for a page-type block corresponding to the second page. The method can include receiving an input relative to the link on the first page. The input incudes moving a cursor to a location that is within a threshold distance from the link. In response to the input, the method can include determining that the second page includes the summary property. In response to determining that the second page includes the summary property, the method can include causing display of a preview of the second page while displaying the link on the first page. The preview can include the textual summary of the second page that was generated using the generative AI system.

In another example, an electronic server device is configured for providing a link and associated preview of content on a workspace. The device can cause display of a link to a second page of the workspace on a first page of the workspace. The first and second pages can be blocks of the workspace. The link can be embedded as an in-page object on the first page. The device can pregenerate a textual summary of the second page by using a generative AI system prior to runtime of the display of the link to the second page in the first page. The textual summary can be stored as a summary property for a page-type block corresponding to the second page. The device can receive an input relative to the link on the first page and determine that the second page includes the summary property in response to the input. In response to determining that the second page includes the summary property, the device can cause display of a preview of the second page. The preview can include the textual summary of the second page that was generated using the generative AI system.

In yet another example, a non-transitory, computer-readable storage medium includes instructions that cause a system to perform a function on a workspace that includes multiple pages when executed by a processor. The system can display on a first page of the workspace a link to a second page of the workspace. The first and second pages can be blocks of the workspace. The link can be embedded as an in-page object on the first page. The system can pregenerate a textual summary of the second page by using a generative AI system prior to runtime of the display of the link to the second page in the first page. The textual summary can be stored as a summary property for a page-type block corresponding to the second page. The system can receive an input relative to the link on the first page. In response to the input, the system can determine that the second page includes the summary property. In response to determining that the second page includes the summary property, the system can cause display of a preview of the second page. The preview can include the textual summary of the second page that was generated using the generative AI system.

Another aspect of the present technology utilizes content from in-page content blocks that is selected based on location and/or the content itself in the link previews. A page can include multiple in-page objects (blocks) that include content (e.g., text, links, images, videos, AI command instructions, or control items). The preview can include a preselected subset of the multiple blocks. The preselection can be done based on respective locations of the blocks and/or content included in the blocks.

In one example, a computer-implemented method for providing a link and associated preview of content on a workspace includes causing, on a first page of the workspace, display of a link to a second page of the workspace. The first and second pages can be blocks of the workspace. The link can be embedded as an in-page object on the first page. The second page can embed multiple blocks as in-page objects. Each block can have multiple properties that are defined by a block type of the respective block. The method can include preselecting a subset of the multiple blocks to include in a preview of the second page prior to runtime of the display of the link to the second page in the first page. The subset of the multiple blocks can be less than an entirety of the multiple blocks of the second page. The subset of the multiple blocks can be preselected from among the multiple blocks based on content of a respective block or a location of the respective block on the second page. The method can include receiving an input relative to the link on the first page. The input can include moving a cursor to a location that is within a threshold distance from the link. In response to the input, the method can include causing display of the preview of the subset of the multiple blocks from the second page while displaying the link on the first page.

In another example, an electronic server device is configured to provide a link and associated preview of content on a workspace. The server device can cause, on a first page of the workspace, display of a link to a second page of the workspace. The second page can embed multiple blocks as in-page objects. The server device can preselect a subset of the multiple blocks to include in a preview of the second page prior to runtime of the display of the link to the second page in the first page. The subset of the multiple blocks can be preselected from among the multiple blocks based on content of a respective block or a location of the respective block on the second page. In response to an input relative to the link on the first page, the server device can cause display of the preview of the subset of the multiple blocks from the second page while displaying the link on the first page.

In yet another example, a non-transitory, computer-readable storage medium includes instructions that cause the system to perform a function on a workspace that includes multiple pages. The system can cause, on a first page of the workspace, display of a link to a second page of the workspace. The second page can embed multiple blocks as in-page objects. The system can preselect a subset of the multiple blocks to include in a preview of the second page prior to runtime of the display of the link to the second page in the first page. The subset of the multiple blocks can be preselected from among the multiple blocks based on content of a respective block or a location of the respective block on the second page. In response to an input relative to the link on the first page, the system can cause display of the preview of the subset of the multiple blocks from the second page while displaying the link on the first page.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail to avoid unnecessarily obscuring the descriptions of examples.

### Block Data Model

The disclosed technology includes a block data model (“block model”). The blocks are dynamic units of information that can be transformed into other block types and move across workspaces. The block model allows users to customize how their information is moved, organized, and shared. Hence, blocks contain information but are not siloed.

Blocks are singular pieces that represent all units of information inside an editor. In one example, text, images, lists, a row in a database, etc., are all blocks in a workspace. The attributes of a block determine how that information is rendered and organized. Every block can have attributes including an identifier (ID), properties, and type. Each block is uniquely identifiable by its ID. The properties can include a data structure containing custom attributes about a specific block. An example of a property is “title,” which stores text content of block types such as paragraphs, lists, and the title of a page. More elaborate block types require additional or different properties, such as a page block in a database with user-defined properties. Every block can have a type, which defines how a block is displayed and how the block's properties are interpreted.

A block has attributes that define its relationship with other blocks. For example, the attribute “content” is an array (or ordered set) of block IDs representing the content inside a block, such as nested bullet items in a bulleted list or the text inside a toggle. The attribute “parent” is the block ID of a block's parent, which can be used for permissions. Blocks can be combined with other blocks to track progress and hold all project information in one place.

A block type is what specifies how the block is rendered in a user interface (UI), and the block's properties and content are interpreted differently depending on that type. Changing the type of a block does not change the block's properties or content—it only changes the type attribute. The information is thus rendered differently or even ignored if the property is not used by that block type. Decoupling property storage from block type allows for efficient transformation and changes to rendering logic and is useful for collaboration.

Blocks can be nested inside of other blocks (e.g., infinitely nested sub-pages inside of pages). The content attribute of a block stores the array of block IDs (or pointers) referencing those nested blocks. Each block defines the position and order in which its content blocks are rendered. This hierarchical relationship between blocks and their render children are referred to herein as a “render tree.” In one example, page blocks display their content in a new page, instead of rendering it indented in the current page. To see this content, a user would need to click into the new page.

In the block model, indentation is structural (e.g., reflects the structure of the render tree). In other words, when a user indents something, the user is manipulating relationships between blocks and their content, not just adding a style. For example, pressing Indent in a content block can add that block to the content of the nearest sibling block in the content tree.

Blocks can inherit permissions of blocks in which they are located (which are above them in the tree). Consider a page: to read its contents, a user must be able to read the blocks within that page. However, there are two reasons one cannot use the content array to build the permissions system. First, blocks are allowed to be referenced by multiple content arrays to simplify collaboration and a concurrency model. But because a block can be referenced in multiple places, it is ambiguous which block it would inherit permissions from. The second reason is mechanical. To implement permission checks for a block, one needs to look up the tree, getting that block's ancestors all the way up to the root of the tree (which is the workspace). Trying to find this ancestor path by searching through all blocks' content arrays is inefficient, especially on the client. Instead, the model uses an “upward pointer”—the parent attribute—for the permission system. The upward parent pointers and the downward content pointers mirror each other.

A block's life starts on the client. When a user takes an action in the interface-typing in the editor, dragging blocks around a page—these changes are expressed as operations that create or update a single record. The “records” refer to persisted data, such as blocks, users, workspaces, etc. Because many actions usually change more than one record, operations are batched into transactions that are committed (or rejected) by the server as a group.

Creating and updating blocks can be performed by, for example, pressing Enter on a keyboard. First, the client defines all the initial attributes of the block, generating a new unique ID, setting the appropriate block type (to_do), and filling in the block's properties (an empty title, and checked: [[“No”]]). The client builds operations to represent the creation of a new block with those attributes. New blocks are not created in isolation: blocks are also added to their parent's content array, so they are in the correct position in the content tree. As such, the client also generates an operation to do so. All these individual change operations are grouped into a transaction. Then, the client applies the operations in the transaction to its local state. New block objects are created in memory and existing blocks are modified. In native apps, the model caches all records that are accessed locally in an LRU (least recently used) cache on top of SQLite or IndexedDB, referred to as RecordCache. When records are changed on a native app, the model also updates the local copies in RecordCache. The editor re-renders to draw the newly created block onto the display. At the same time, the transaction is saved into TransactionQueue, the part of the client responsible for sending all transactions to the model's servers so that the data is persisted and shared with collaborators. TransactionQueue stores transactions safely in IndexedDB or SQLite (depending on the platform) until they are persisted by the server or rejected.

A block can be saved on a server to be shared with others. Usually, TransactionQueue sits empty, so the transaction to create the block is sent to the server in an application programming interface (API) request. In one example, the transaction data is serialized to JSON and posted to the/saveTransactions API endpoint. Save Transactions gets the data into source-of-truth databases, which store all block data as well as other kinds of persisted records. Once the request reaches the API server, all the blocks and parents involved in the transaction are loaded. This gives a “before” picture in memory. The block model duplicates the “before” data that had just been loaded in memory. Next, the block model applies the operations in the transaction to the new copy to create the “after” data. Then the model uses both “before” and “after” data to validate the changes for permissions and data coherency. If everything checks out, all created or changed records are committed to the database-meaning the block has now officially been created. At this point, a “success” HTTP response to the original API request is sent by the client. This confirms that the client knows the transaction was saved successfully and that it can move on to saving the next transaction in the TransactionQueue. In the background, the block model schedules additional work depending on the kind of change made for the transaction. For example, the block model can schedule version history snapshots and indexing block text for a Quick Find function. The block model also notifies MessageStore, which is a real-time updates service, about the changes that were made.

The block model provides real-time updates to, for example, almost instantaneously show new blocks to members of a teamspace. Every client can have a long-lived WebSocket connection to the MessageStore. When the client renders a block (or page, or any other kind of record), the client subscribes to changes of that record from MessageStore using the WebSocket connection. When a team member opens the same page, the member is subscribed to changes of all those blocks. After changes have been made through the saveTransactions process, the API notifies MessageStore of new recorded versions. MessageStore finds client connections subscribed to those changing records and passes on the new version through their WebSocket connection. When a team member's client receives version update notifications from MessageStore, it verifies that version of the block in its local cache. Because the versions from the notification and the local block are different, the client sends a syncRecordValues API request to the server with the list of outdated client records. The server responds with the new record data. The client uses this response data to update the local cache with the new version of the records, then re-renders the user interface to display the latest block data.

Blocks can be shared instantaneously with collaborators. In one example, a page is loaded using only local data. On the web, block data is pulled from being in memory. On native apps, loading blocks that are not in memory are loaded from the RecordCache persisted storage. However, if missing block data is needed, the data is requested from an API. The API method for loading the data for a page is referred to herein as loadPageChunk; it descends from a starting point (likely the block ID of a page block) down the content tree and returns the blocks in the content tree plus any dependent records needed to properly render those blocks. Several layers of caching for loadPageChunk are used, but in the worst case, this API might need to make multiple trips to the database as it recursively crawls down the tree to find blocks and their record dependencies. All data loaded by loadPageChunk is put into memory (and saved in the RecordCache if using the app). Once the data is in memory, the page is laid out and rendered using React.

### Software Platform

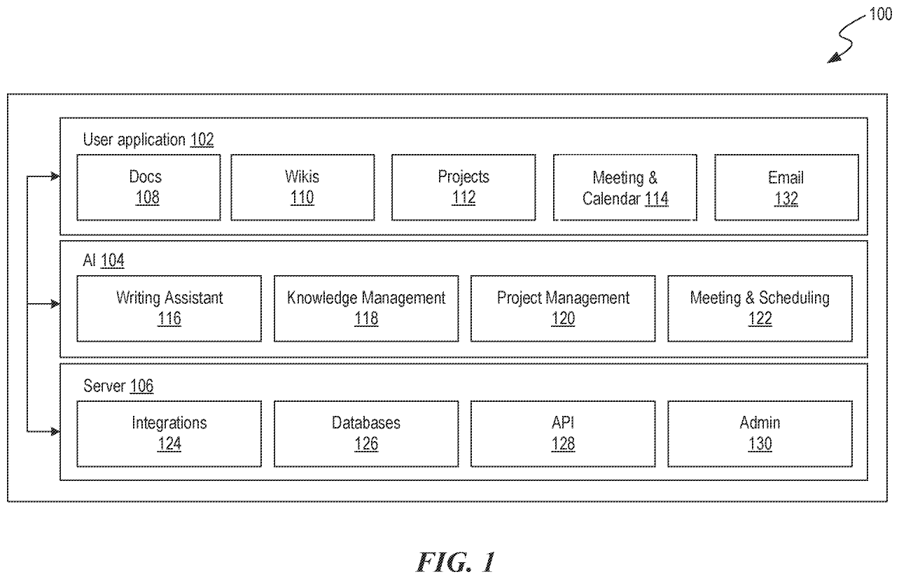

FIG. 1 is a block diagram of an example platform 100. The platform 100 provides users with an all-in-one workspace for data and project management. The platform 100 can include a user application 102, an AI tool 104, and a server 106. The user application 102, the AI tool 104, and the server 106 are in communication with each other via a network.

In some implementations, the user application 102 is a cross-platform software application configured to work on several computing platforms and web browsers. The user application 102 can include a variety of templates. A template refers to a prebuilt page that a user can add to a workspace within the user application 102. The templates can be directed to a variety of functions. Exemplary templates include a docs template 108, a wikis template 110, a projects template 112, a meeting and calendar template 114, and an email template 132. In some implementations, a user can generate, save, and share customized templates with other users.

The user application 102 templates can be based on content “blocks.” For example, the templates of the user application 102 include a predefined and/or pre-organized set of blocks that can be customized by the user. Blocks are content containers within a template that can include text, images, objects, tables, maps, emails, and/or other pages (e.g., nested pages or sub-pages). Blocks can be assigned to certain properties. The blocks are defined by boundaries having dimensions. The boundaries can be visible or non-visible for users. For example, a block can be assigned as a text block (e.g., a block including text content), a heading block (e.g., a block including a heading) or a sub-heading block having a specific location and style to assist in organizing a page. A block can be assigned as a list block to include content in a list format. A block can be assigned as an AI prompt block (also referred to as a “prompt block”) that enables a user to provide instructions (e.g., prompts) to the AI tool 104 to perform functions. A block can also be assigned to include audio, video, or image content.

A user can add, edit, and remove content from the blocks. The user can also organize the content within a page by moving the blocks around. In some implementations, the blocks are shared (e.g., by copying and pasting) between the different templates within a workspace. For example, a block embedded within multiple templates can be configured to show edits synchronously.

The docs template 108 is a document generation and organization tool that can be used for generating a variety of documents. For example, the docs template 108 can be used to generate pages that are easy to organize, navigate, and format. The wikis template 110 is a knowledge management application having features similar to the pages generated by the docs template 108 but that can additionally be used as a database. The wikis template 110 can include, for example, tags configured to categorize pages by topic and/or include an indication of whether the provided information is verified to indicate its accuracy and reliability. The projects template 112 is a project management and note-taking software tool. The projects template 112 can allow the users, either as individuals or as teams, to plan, manage, and execute projects in a single forum. The meeting and calendar template 114 is a tool for managing tasks and timelines. In addition to traditional calendar features, the meeting and calendar template 114 can include blocks for categorizing and prioritizing scheduled tasks, generating to-do and action item lists, tracking productivity, etc. The various templates of the user application 102 can be included under a single workspace and include synchronized blocks. For example, a user can update a project deadline on the projects template 112, which can be automatically synchronized to the meeting and calendar template 114. The various templates of the user application 102 can be shared within a team, allowing multiple users to modify and update the workspace concurrently.

The email template 132 allows the users to customize their inbox by representing the inbox as a customizable database where the user can add custom columns and create custom views with layouts. One view can include multiple layouts including a calendar layout, a summary layout, and urgent information layout. Each view can include a customized structure including custom criteria, custom properties, and custom actions. The custom properties can be specific to a view such as artificial intelligence-extracted properties, and/or heuristic-based properties. The custom actions can trigger automatically when a message enters the view. The custom actions can include deterministic rules like “Archive this,” or assistant workflows like responding to support messages by searching user applications 102 or filing support tickets. In addition, the view can include actions, such as buttons, that are custom to the view and perform operations on the messages in the inbox. Only the customized structure can be shared with other users of the system, or both the customized structure and the messages can be shared.

The integration of the docs template 108, the wikis template 110, the projects template 112, the meeting and calendar template 114, and the email template 132 enables linking and embedding of templates within other templates. For example, an email sent from an email address within the system 100 to another email address within the system 100, can include an embedding of a document within the system 100, or an embedding of a block in the document. In another example, a wiki can link to a meeting within the calendar.

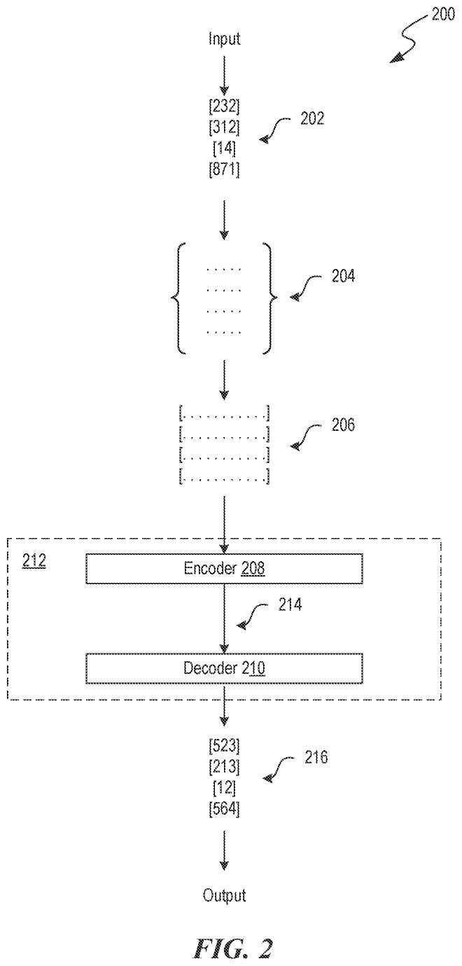

The AI tool 104 is an integrated AI assistant that enables AI-based functions for the user application 102. In one example, the AI tool 104 is based on a neural network architecture, such as the transformer 212 described in FIG. 2. The AI tool 104 can interact with blocks embedded within the templates on a workspace of the user application 102. For example, the AI tool 104 can include a writing assistant tool 116, a knowledge management tool 118, a project management tool 120, and a meeting and scheduling tool 122. The different tools of the AI tool 104 can be interconnected and interact with different blocks and templates of the user application 102.

The writing assistant tool 116 can operate as a generative AI tool for creating content for the blocks in accordance with instructions received from a user. Creating the content can include, for example, summarizing, generating new text, or brainstorming ideas. For example, in response to a prompt received as a user input that instructs the AI to describe what the climate is like in New York, the writing assistant tool 116 can generate a block including a text that describes the climate in New York. As another example, in response to a prompt that requests ideas on how to name a pet, the writing assistant tool 116 can generate a block including a list of creative pet names. The writing assistant tool 116 can also operate to modify existing text. For example, the writing assistant can shorten, lengthen, or translate existing text, correct grammar and typographical errors, or modify the style of the text (e.g., a social media style versus a formal style).

The knowledge management tool 118 can use AI to categorize, organize, and share knowledge included in the workspace. In some implementations, the knowledge management tool 118 can operate as a question-and-answer assistant. For example, a user can provide instructions on a prompt block to ask a question. In response to receiving the question, the knowledge management tool 118 can provide an answer to the question, for example, based on information included in the wikis template 110. The project management tool 120 can provide AI support for the projects template 112. The AI support can include auto filling information based on changes within the workspace or automatically track project development. For example, the project management tool 120 can use AI for task automation, data analysis, real-time monitoring of project development, allocation of resources, and/or risk mitigation. The meeting and scheduling tool 122 can use AI to organize meeting notes, unify meeting records, list key information from meeting minutes, and/or connect meeting notes with deliverable deadlines.

The server 106 can include various units (e.g., including compute and storage units) that enable the operations of the AI tool 104 and workspaces of the user application 102. The server 106 can include an integrations unit 124, an application programming interface (API) 128, databases 126, and an administration (admin) unit 130. The databases 126 are configured to store data associated with the blocks. The data associated with the blocks can include information about the content included in the blocks, the function associated with the blocks, and/or any other information related to the blocks. The API 128 can be configured to communicate the block data between the user application 102, the AI tool 104, and the databases 126. The API 128 can also be configured to communicate with remote server systems, such as AI systems. For example, when a user performs a transaction within a block of a template of the user application 102 (e.g., in a docs template 108), the API 128 processes the transaction and saves the changes associated with the transaction to the database 126. The integrations unit 124 is a tool connecting the platform 200 with external systems and software platforms. Such external systems and platforms can include other databases (e.g., cloud storage spaces), messaging software applications, or audio or video conference applications. The administration unit 130 is configured to manage and maintain the operations and tasks of the server 106. For example, the administration unit 130 can manage user accounts, data storage, security, performance monitoring, etc.

### Transformer for Neural Network

To assist in understanding the present disclosure, some concepts relevant to neural networks and machine learning (ML) are discussed herein. Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which are not discussed in detail here.

A deep neural network (DNN) is a type of neural network having multiple layers and/or a large number of neurons. The term DNN can encompass any neural network having multiple layers, including convolutional neural networks (CNNs), recurrent neural networks (RNNs), multilayer perceptrons (MLPs), Generative Adversarial Networks (GANs), Variational Autoencoders (VAEs), and Auto-regressive Models, among others.

DNNs are often used as ML-based models for modeling complex behaviors (e.g., human language, image recognition, object classification, etc.) in order to improve the accuracy of outputs (e.g., more accurate predictions) such as, for example, as compared with models with fewer layers. In the present disclosure, the term “ML-based model” or more simply “ML model” may be understood to refer to a DNN. Training an ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model.

As an example, to train an ML model that is intended to model human language (also referred to as a “language model”), the training dataset may be a collection of text documents, referred to as a “text corpus” (or simply referred to as a “corpus”). The corpus may represent a language domain (e.g., a single language), a subject domain (e.g., scientific papers), and/or may encompass another domain or domains, be they larger or smaller than a single language or subject domain. For example, a relatively large, multilingual, and non-subject-specific corpus can be created by extracting text from online webpages and/or publicly available social media posts. Training data can be annotated with ground truth labels (e.g., each data entry in the training dataset can be paired with a label) or may be unlabeled.

Training an ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or can be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data can be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters can be determined based on the measured performance of one or more of the trained ML models, and the first step of training (e.g., with the training set) may begin again on a different ML model described by the new set of determined hyperparameters. In this way, these steps can be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training an ML model. Backpropagation is used to adjust (e.g., update) the value of the parameters in the ML model, with the goal of optimizing the objective function. For example, a defined loss function is calculated by forward propagation of an input to obtain an output of the ML model and a comparison of the output value with the target value. Backpropagation calculates a gradient of the loss function with respect to the parameters of the ML model, and a gradient algorithm (e.g., gradient descent) is used to update (e.g., “learn”) the parameters to reduce the loss function. Backpropagation is performed iteratively so that the loss function is converged or minimized. Other techniques for learning the parameters of the ML model can be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters can then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of an ML model typically involves further training the ML model on a number of data samples (which may be smaller in number/cardinality than those used to train the model initially) that closely target the specific task. For example, an ML model for generating natural language that has been trained generically on publicly available text corpora may be, e.g., fine-tuned by further training using specific training samples. The specific training samples can be used to generate language in a certain style or in a certain format. For example, the ML model can be trained to generate a blog post having a particular style and structure with a given topic.

Some concepts in ML-based language models are now discussed. It may be noted that, while the term “language model” has been commonly used to refer to an ML-based language model, there could exist non-ML language models. In the present disclosure, the term “language model” can refer to an ML-based language model (e.g., a language model that is implemented using a neural network or other ML architecture), unless stated otherwise. For example, unless stated otherwise, the “language model” encompasses LLMs.

A language model can use a neural network (typically a DNN) to perform natural language processing (NLP) tasks. A language model can be trained to model how words relate to each other in a textual sequence, based on probabilities. A language model may contain hundreds of thousands of learned parameters or, in the case of an LLM, can contain millions or billions of learned parameters or more. As non-limiting examples, a language model can generate text, translate text, summarize text, answer questions, write code (e.g., Python, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

A type of neural network architecture, referred to as a “transformer,” can be used for language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

FIG. 2 is a block diagram of an example transformer 212. A transformer is a type of neural network architecture that uses self-attention mechanisms to generate predicted output based on input data that has some sequential meaning (e.g., the order of the input data is meaningful, which is the case for most text input). Self-attention is a mechanism that relates different positions of a single sequence to compute a representation of the same sequence. Although transformer-based language models are described herein, the present disclosure may be applicable to any ML-based language model, including language models based on other neural network architectures such as recurrent neural network (RNN)-based language models.

The transformer 212 includes an encoder 208 (which can include one or more encoder layers/blocks connected in series) and a decoder 210 (which can include one or more decoder layers/blocks connected in series). Generally, the encoder 208 and the decoder 210 each include multiple neural network layers, at least one of which can be a self-attention layer. The parameters of the neural network layers can be referred to as the parameters of the language model.

The transformer 212 can be trained to perform certain functions on a natural language input. Examples of the functions include summarizing existing content, brainstorming ideas, writing a rough draft, fixing spelling and grammar, and translating content. Summarizing can include extracting key points or themes from an existing content in a high-level summary. Brainstorming ideas can include generating a list of ideas based on provided input. For example, the ML model can generate a list of names for a startup or costumes for an upcoming party. Writing a rough draft can include generating writing in a particular style that could be useful as a starting point for the user's writing. The style can be identified as, e.g., an email, a blog post, a social media post, or a poem. Fixing spelling and grammar can include correcting errors in an existing input text. Translating can include converting an existing input text into a variety of different languages. In some implementations, the transformer 212 is trained to perform certain functions on other input formats than natural language input. For example, the input can include objects, images, audio content, or video content, or a combination thereof.

The transformer 212 can be trained on a text corpus that is labeled (e.g., annotated to indicate verbs, nouns) or unlabeled. LLMs can be trained on a large unlabeled corpus. The term “language model,” as used herein, can include an ML-based language model (e.g., a language model that is implemented using a neural network or other ML architecture), unless stated otherwise. Some LLMs can be trained on a large multi-language, multi-domain corpus to enable the model to be versatile at a variety of language-based tasks such as generative tasks (e.g., generating human-like natural language responses to natural language input).

FIG. 2 illustrates an example of how the transformer 212 can process textual input data. Input to a language model (whether transformer-based or otherwise) typically is in the form of natural language that can be parsed into tokens. The term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph) into a sequence of shorter segments that are converted to numerical representations referred to as tokens (or “compute tokens”). Typically, a token can be an integer that corresponds to the index of a text segment (e.g., a word) in a vocabulary dataset. Often, the vocabulary dataset is arranged by frequency of use. Commonly occurring text, such as punctuation, can have a lower vocabulary index in the dataset and thus be represented by a token having a smaller integer value than less commonly occurring text. Tokens frequently correspond to words, with or without white space appended. In some implementations, a token can correspond to a portion of a word.

For example, the word “greater” can be represented by a token for [great] and a second token for [er]. In another example, the text sequence “write a summary” can be parsed into the segments [write], [a], and [summary], each of which can be represented by a respective numerical token. In addition to tokens that are parsed from the textual sequence (e.g., tokens that correspond to words and punctuation), there can also be special tokens to encode non-textual information. For example, a [CLASS] token can be a special token that corresponds to a classification of the textual sequence (e.g., can classify the textual sequence as a list, a paragraph), an [EOT] token can be another special token that indicates the end of the textual sequence, other tokens can provide formatting information, etc.

In FIG. 2, a short sequence of tokens 202 corresponding to the input text is illustrated as input to the transformer 212. Tokenization of the text sequence into the tokens 202 can be performed by some pre-processing tokenization module such as, for example, a byte-pair encoding tokenizer (the “pre” referring to the tokenization occurring prior to the processing of the tokenized input by the LLM), which is not shown in FIG. 2 for brevity. In general, the token sequence that is inputted to the transformer 212 can be of any length up to a maximum length defined based on the dimensions of the transformer 212. Each token 202 in the token sequence is converted into an embedding vector 206 (also referred to as “embedding 206”).

An embedding 206 is a learned numerical representation (such as, for example, a vector) of a token that captures some semantic meaning of the text segment represented by the token 202. The embedding 206 represents the text segment corresponding to the token 202 in a way such that embeddings corresponding to semantically related text are closer to each other in a vector space than embeddings corresponding to semantically unrelated text. For example, assuming that the words “write,” “a,” and “summary” each correspond to, respectively, a “write” token, an “a” token, and a “summary” token when tokenized, the embedding 206 corresponding to the “write” token will be closer to another embedding corresponding to the “jot down” token in the vector space as compared to the distance between the embedding 206 corresponding to the “write” token and another embedding corresponding to the “summary” token.

The vector space can be defined by the dimensions and values of the embedding vectors. Various techniques can be used to convert a token 202 to an embedding 206. For example, another trained ML model can be used to convert the token 202 into an embedding 206. In particular, another trained ML model can be used to convert the token 202 into an embedding 206 in a way that encodes additional information into the embedding 206 (e.g., a trained ML model can encode positional information about the position of the token 202 in the text sequence into the embedding 206). In some implementations, the numerical value of the token 202 can be used to look up the corresponding embedding in an embedding matrix 204, which can be learned during training of the transformer 212.

The generated embeddings 206 are input into the encoder 208. The encoder 208 serves to encode the embeddings 206 into feature vectors 214 that represent the latent features of the embeddings 206. The encoder 208 can encode positional information (i.e., information about the sequence of the input) in the feature vectors 214. The feature vectors 214 can have very high dimensionality (e.g., on the order of thousands or tens of thousands), with each element in a feature vector 214 corresponding to a respective feature. The numerical weight of each element in a feature vector 214 represents the importance of the corresponding feature. The space of all possible feature vectors 214 that can be generated by the encoder 208 can be referred to as a latent space or feature space.

Conceptually, the decoder 210 is designed to map the features represented by the feature vectors 214 into meaningful output, which can depend on the task that was assigned to the transformer 212. For example, if the transformer 212 is used for a translation task, the decoder 210 can map the feature vectors 214 into text output in a target language different from the language of the original tokens 202. Generally, in a generative language model, the decoder 210 serves to decode the feature vectors 214 into a sequence of tokens. The decoder 210 can generate output tokens 216 one by one. Each output token 216 can be fed back as input to the decoder 210 in order to generate the next output token 216. By feeding back the generated output and applying self-attention, the decoder 210 can generate a sequence of output tokens 216 that has sequential meaning (e.g., the resulting output text sequence is understandable as a sentence and obeys grammatical rules). The decoder 210 can generate output tokens 216 until a special [EOT] token (indicating the end of the text) is generated. The resulting sequence of output tokens 216 can then be converted to a text sequence in post-processing. For example, each output token 216 can be an integer number that corresponds to a vocabulary index. By looking up the text segment using the vocabulary index, the text segment corresponding to each output token 216 can be retrieved, the text segments can be concatenated together, and the final output text sequence can be obtained.

In some implementations, the input provided to the transformer 212 includes instructions to perform a function on an existing text. The output can include, for example, a modified version of the input text and instructions to modify the text. The modification can include summarizing, translating, correcting grammar or spelling, changing the style of the input text, lengthening or shortening the text, or changing the format of the text (e.g., adding bullet points or checkboxes). As an example, the input text can include meeting notes prepared by a user and the output can include a high-level summary of the meeting notes. In other examples, the input provided to the transformer includes a question or a request to generate text. The output can include a response to the question, text associated with the request, or a list of ideas associated with the request. For example, the input can include the question “What is the weather like in San Francisco?” and the output can include a description of the weather in San Francisco. As another example, the input can include a request to brainstorm names for a flower shop and the output can include a list of relevant names.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that can be considered to be an encoder-only language model. A decoder-only language model accepts embeddings as input and can use auto-regression to generate an output text sequence. Transformer-XL and GPT-type models can be language models that are considered to be decoder-only language models.

Because GPT-type language models tend to have a large number of parameters, these language models can be considered LLMs. An example of a GPT-type LLM is GPT-3. GPT-3 is a type of GPT language model that has been trained (in an unsupervised manner) on a large corpus derived from documents available online to the public. GPT-3 has a very large number of learned parameters (on the order of hundreds of billions), can accept a large number of tokens as input (e.g., up to 2,048 input tokens), and is able to generate a large number of tokens as output (e.g., up to 2,048 tokens). GPT-3 has been trained as a generative model, meaning that it can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as the Internet. In some implementations, such as, for example, potentially in the case of a cloud-based language model, a remote language model can be hosted by a computer system that can include a plurality of cooperating (e.g., cooperating via a network) computer systems that can be in, for example, a distributed arrangement. Notably, a remote language model can employ multiple processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real time or near real time) can require the use of a plurality of processors/cooperating computing devices as discussed above.

Inputs to an LLM can be referred to as a prompt, which is a natural language input that includes instructions to the LLM to generate a desired output. A computer system can generate a prompt that is provided as input to the LLM via an API (e.g., the API 128 in FIG. 1). As described above, the prompt can optionally be processed or pre-processed into a token sequence prior to being provided as input to the LLM via its API. A prompt can include one or more examples of the desired output, which provides the LLM with additional information to enable the LLM to generate output according to the desired output. Additionally or alternatively, the examples included in a prompt can provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples can be referred to as a zero-shot prompt.

### Hierarchical Organizational Blocks in a Workspace

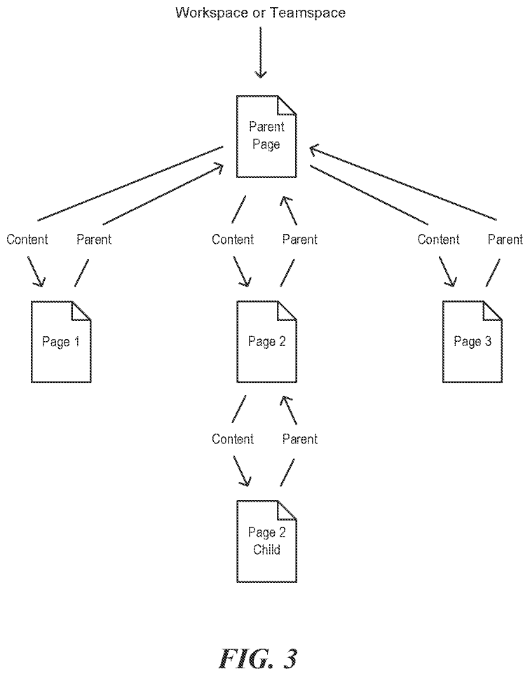

FIG. 3 is a block diagram illustrating a hierarchical organization of pages in a workspace. As described with respect to the block data model of the present technology, a workspace can include multiple pages (e.g., page blocks). The pages (e.g., including parent pages and child or nested pages) can be arranged hierarchically within the workspace or one or more teamspaces, as shown in FIG. 3. The page can include a block such as tabs, lists, images, tables, etc.

A teamspace can refer to a collaborative space associated with a team or an organization that is hierarchically below a workspace. For example, a workspace can include a teamspace accessible by all users of an organization and multiple teamspaces that are accessible by users of different teams. Accessibility generally refers to creating, editing, and/or viewing content (e.g., pages) included in the workspace or the one or more teamspaces.

In the hierarchical organization illustrated in FIG. 3, a parent page (e.g., “Parent Page”) is located hierarchically below the workspace or a teamspace. The parent page includes three children pages (e.g., “Page 1,” “Page 2,” and “Page 3”). Each of the child pages can further include subpages (e.g., “Page 2 Child” which is a grandchild of “Parent Page” and child of “Page 2”). The “Content” arrows in FIG. 3 indicate the relationship between the parents and children while the “Parent” arrows indicate the inheritance of access permissions. The child pages inherit access permission from the (immediate) parent page under which they are located hierarchically (e.g., which is above them in the tree). For example, “Page 2” inherited the access permission of the “Parent page” as a default when it was created under its parent page. Similarly, “Page 2 Child” inherited the access permission of the parent page as a default when it was created under its parent page. “Parent Page,” “Page 2,” and “Page 2 Child” thereby have the same access permission within the workspace.

The relationships and organization of the content can be modified by changing the location of the pages. For example, when a child page is moved to be under a different parent, the child page's access permission modifies to correspond to the access permission of the new parent. Also, when the access permission of “Parent Page” is modified, the access permission of “Page 1,” “Page 2,” and “Page 3” can be automatically modified to correspond to the access permission of “Parent Page” based on the inheritance character of access permissions.

In contrast, however, a user can modify the access permission of the children independently of their parents. For example, the user can modify the access permission of “Page 2 Child” in FIG. 3 so that it is different from the access permission of “Page 2” and “Parent Page.” The access permission of “Page 2 Child” can be modified to be broader or narrower than the access permission of its parents. As an example, “Page 2 Child” can be shared on the internet while “Page 2” is only shared internally to the users associated with the workspace. As another example, “Page 2 Child” can be shared only with an individual user while “Page 2” is shared with a group of users (e.g., a team of the organization associated with the workspace). In some implementations, the hierarchical inheritance of the access permissions described herein can be modified from the previous description. For example, the access permissions of all the pages (parent and children) can be defined as independently changeable.

### Link Previews

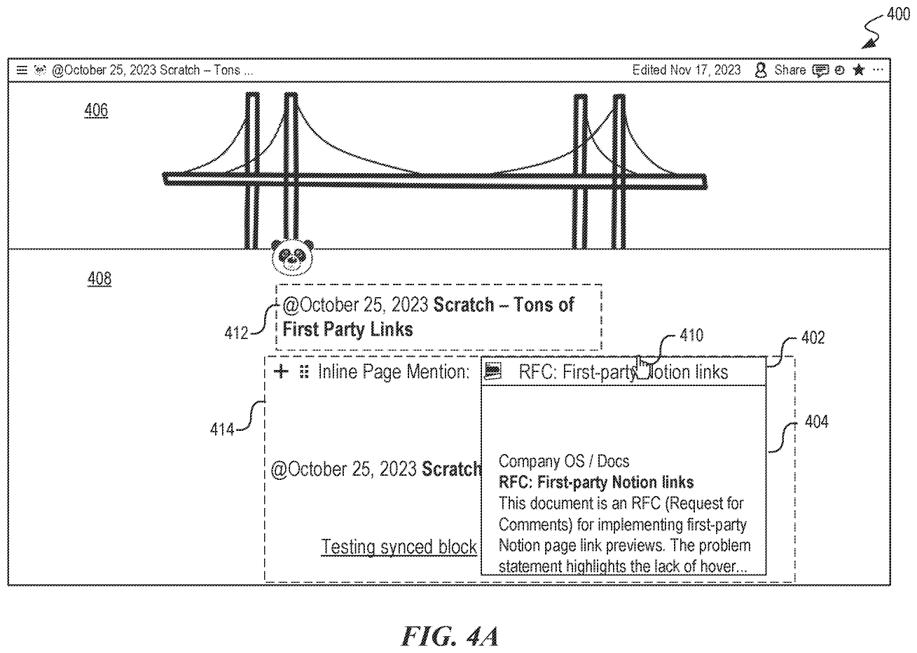

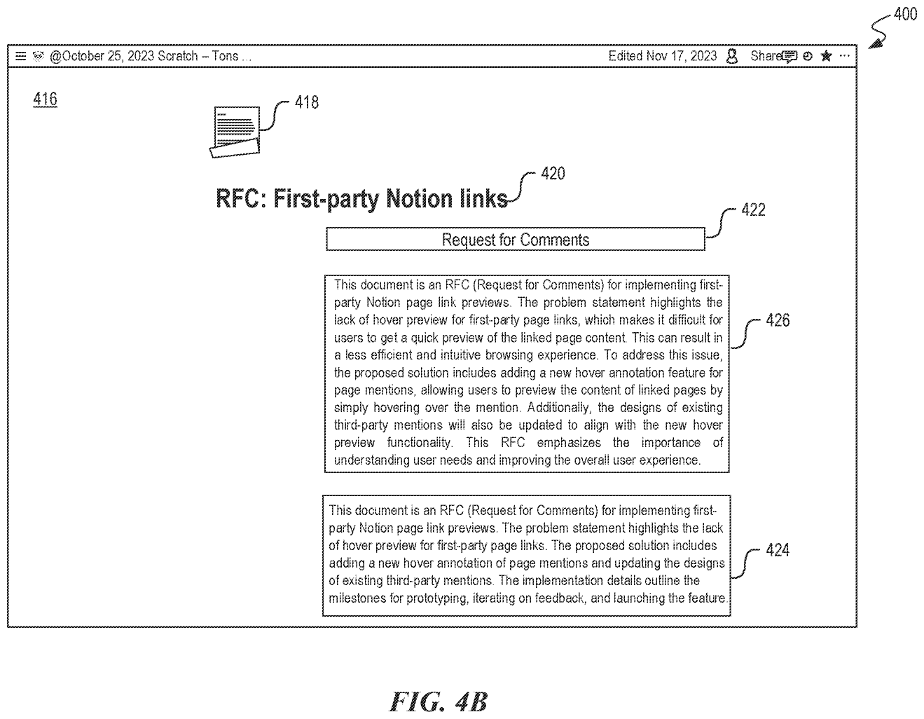

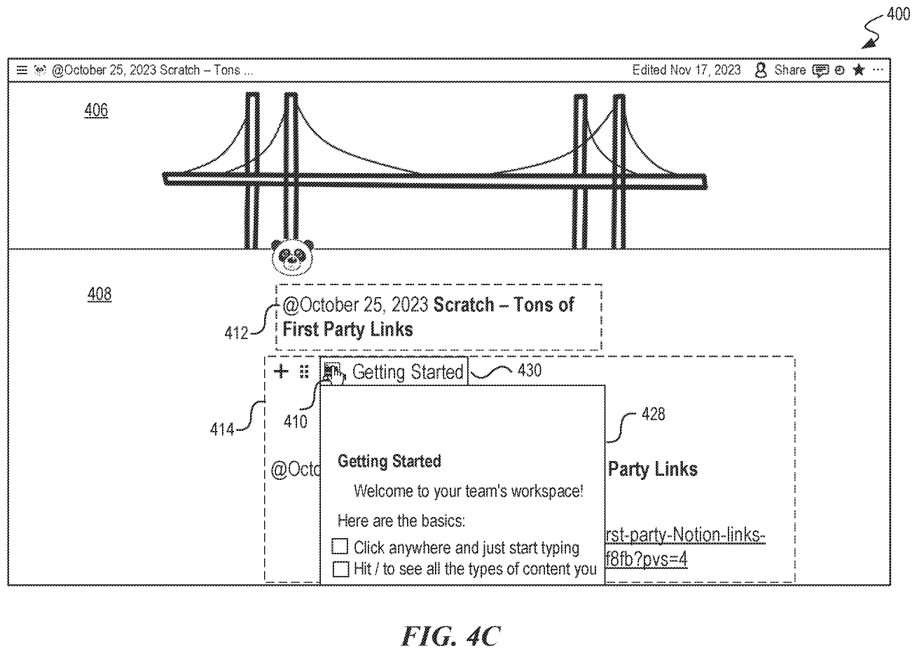

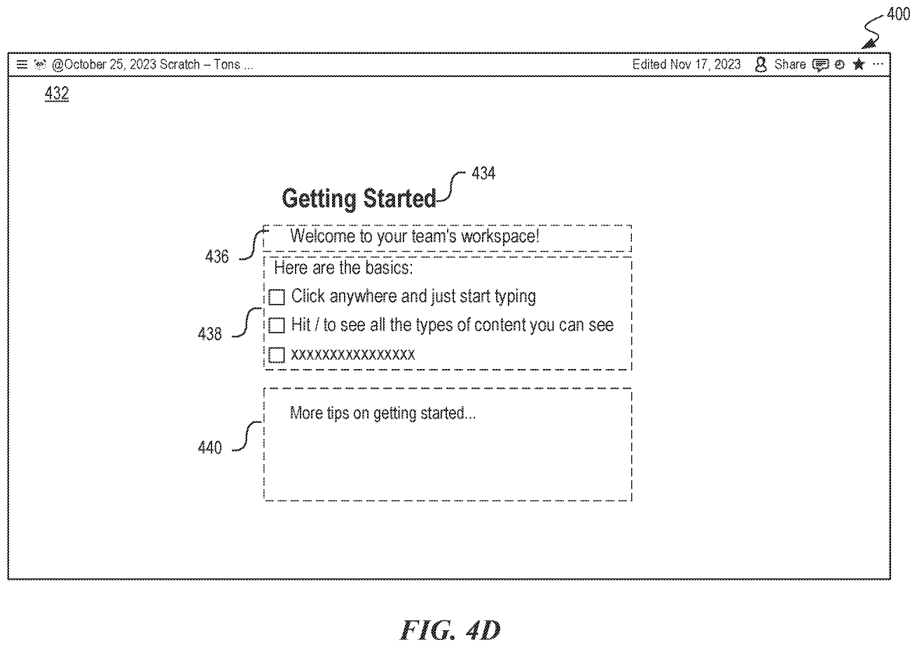

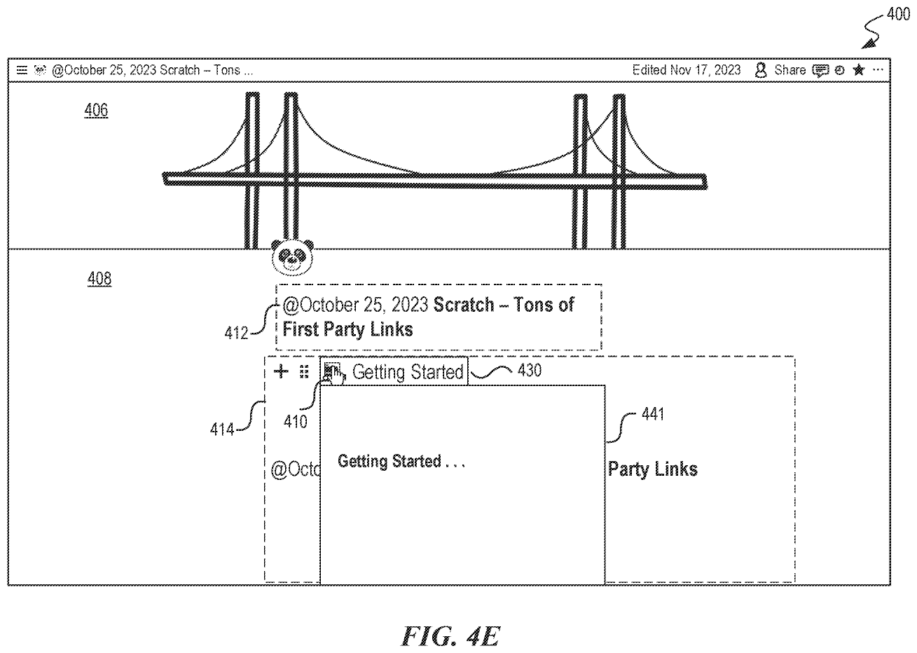

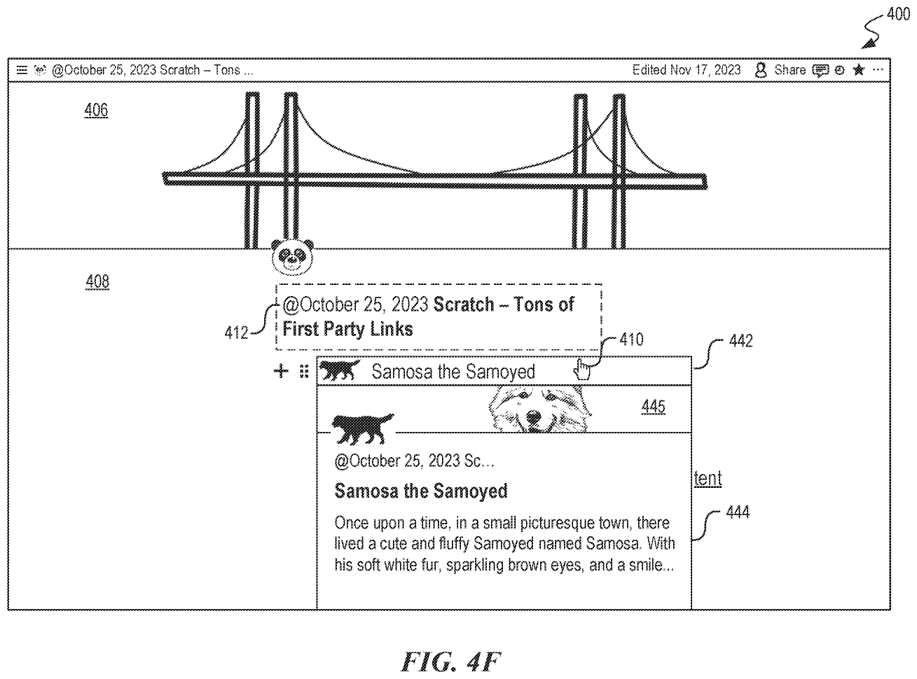

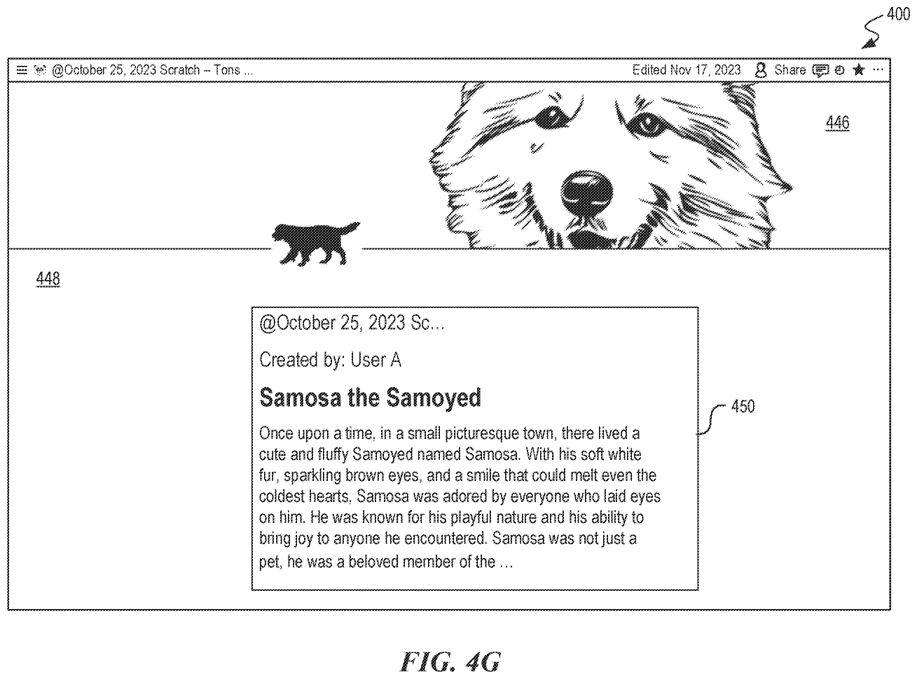

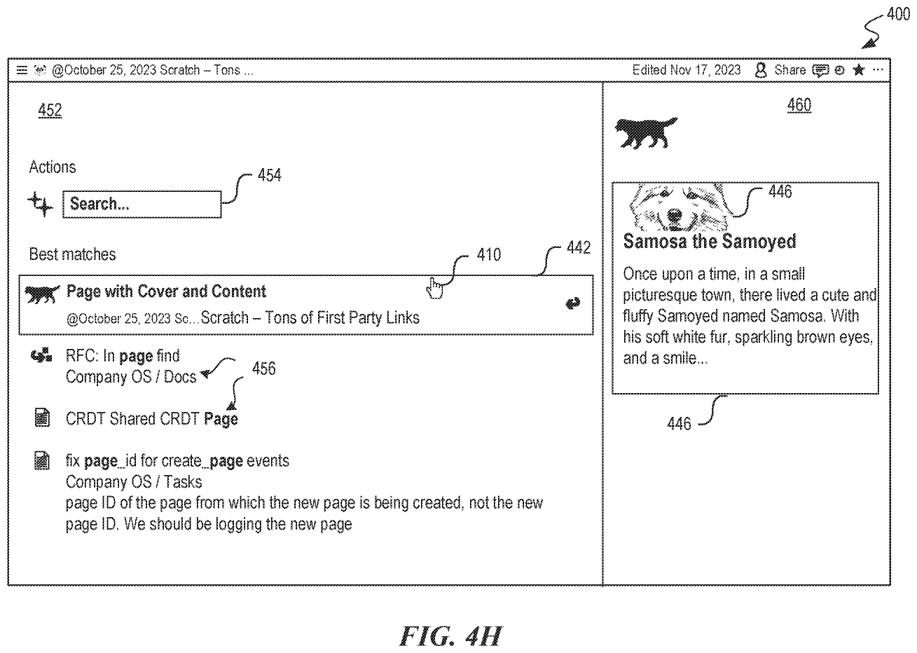

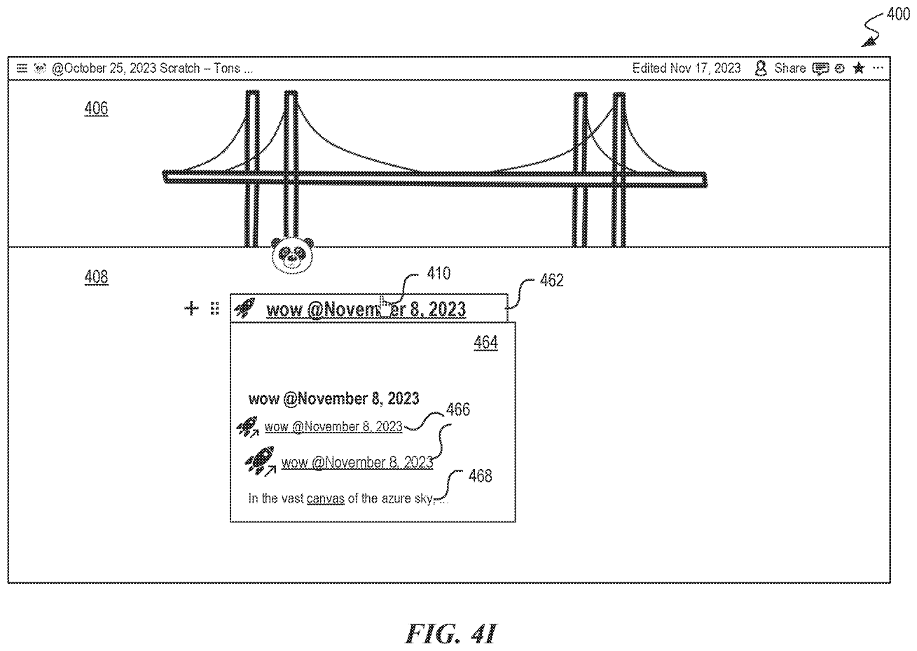

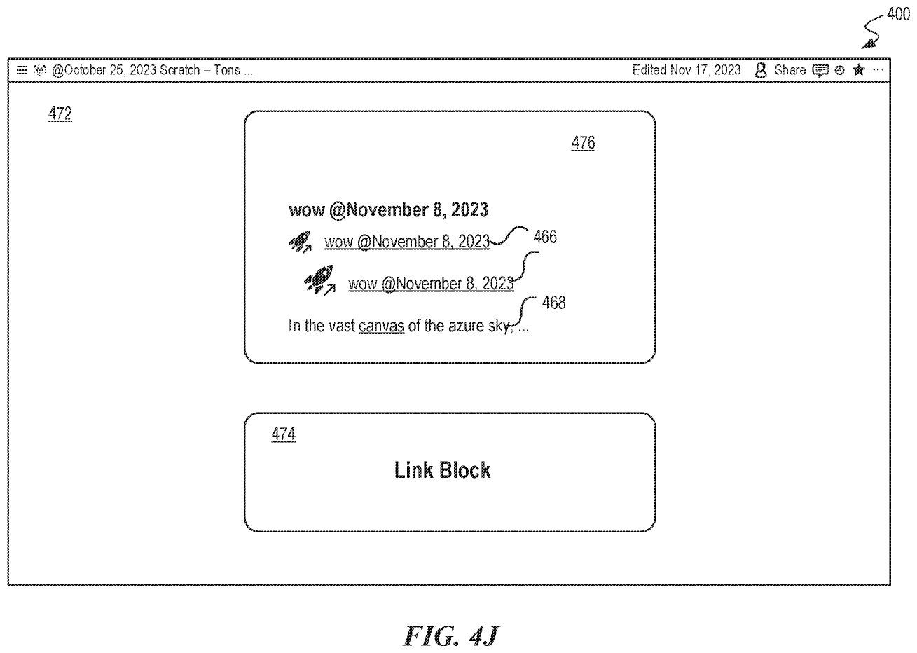

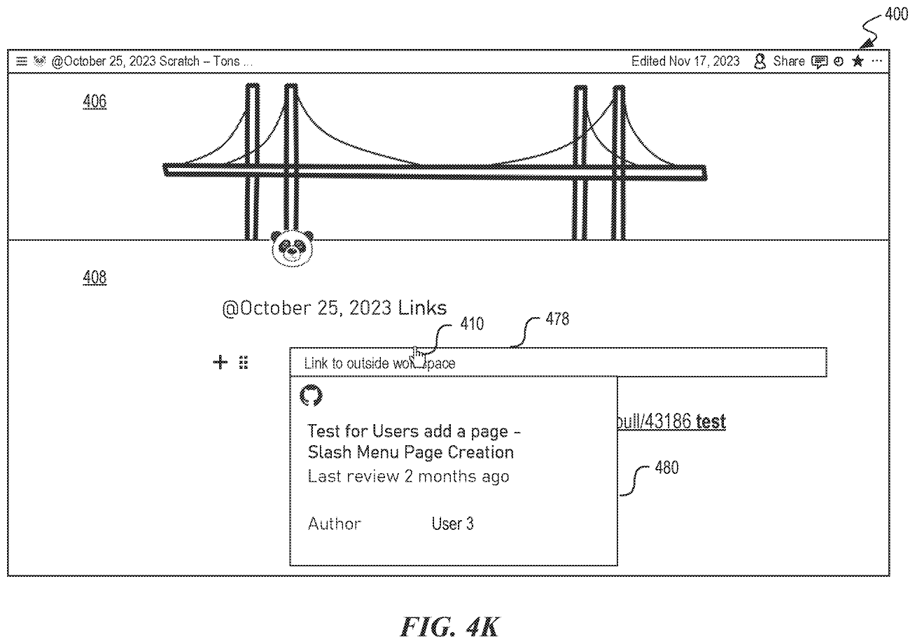

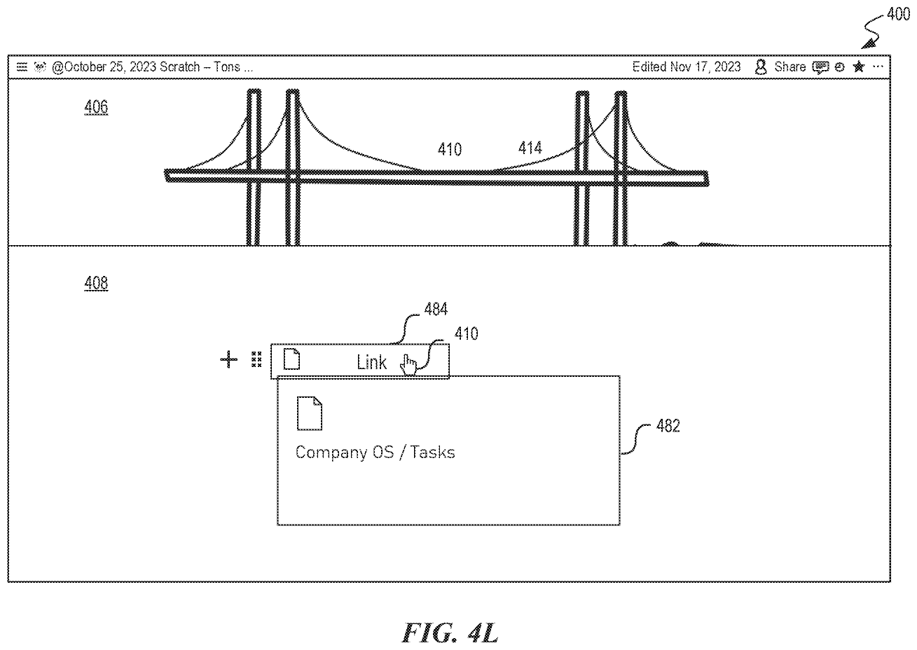

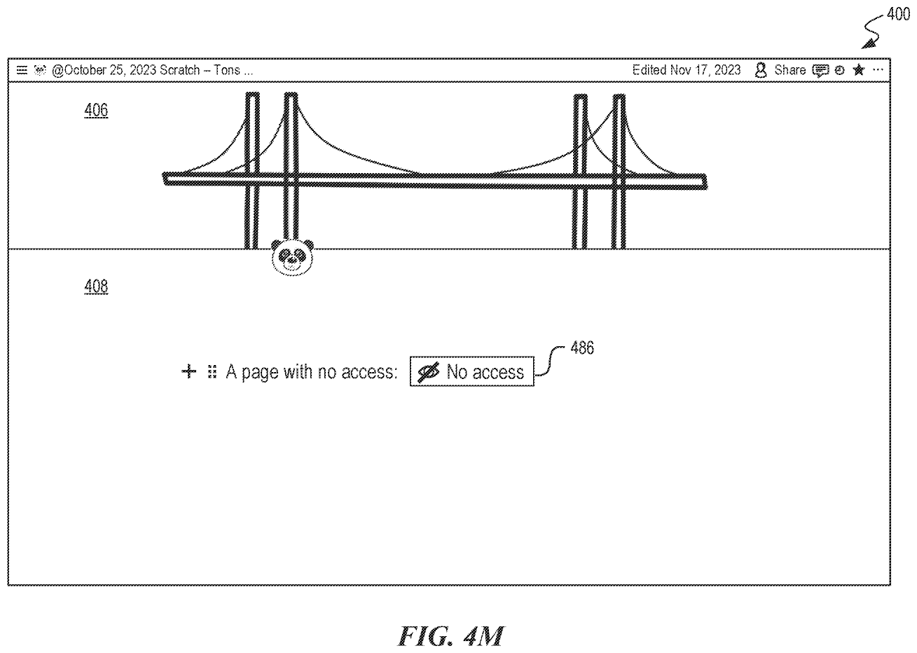

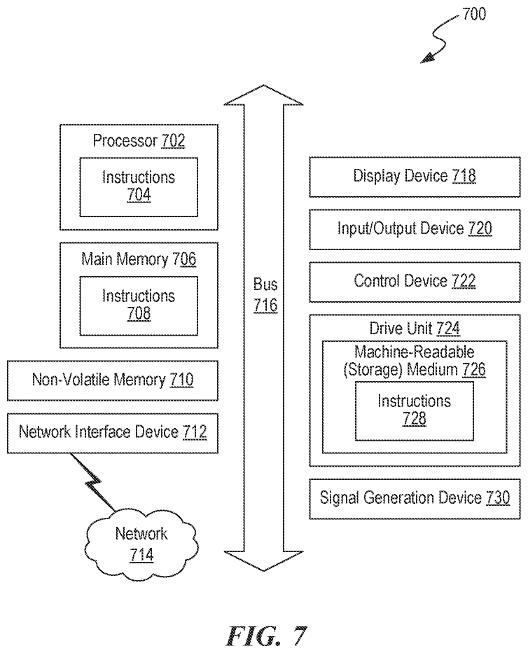

FIGS. 4A through 4M are exemplary views of a workspace user interface 400 (e.g., a graphical user interface) for providing a link and an associated preview of content. The workspace user interface 400 can be displayed on a display of an electronic device (e.g., a computer system 700 described with respect to FIG. 7). The workspace user interface 400 can be associated with a workspace that includes multiple pages of a variety of types. The pages of the workspace can include blocks (also referred to as “content containers” or “containers”). The blocks can be objects that are embedded within the respective pages and that are configured to include content (e.g., content displayed inside the blocks). In some implementations, the multiple pages include templates such as those described with respect to FIG. 1.

The user interface 400 includes a page 408 including a cover image 406 positioned in an upper portion of the page 408. A cover image can be an image object designated as a graphical representation of content of a page. Page 408 further includes a title block 412 and a content block 414. The content block includes text content as well as a link 402. As shown, link 402 is embedded as an object on the content block 414 and is positioned in-line with the text of the content block 414. The page 408 also includes a summary preview 404 that includes a summary preview of the content. The link 402 can provide a connection to content that is external to the page 408. Generally, a link can be an internal link that points to other pages within the same workspace, a relative link that points to a file relative to the current page's location, a link to a social media post or profile, a Uniform Resource Locator (URL) link pointing to a public content source, a link to other external databases (e.g., databases associated with cloud storage, messaging software applications, or audio or video conference applications), or any other type of link. The user interface 400 is configured to provide different types of previews for different types of links.

As shown, in FIG. 4A, the page 408 includes a summary preview 404 of the link 402. The summary preview 404 can be displayed in response to a user input on the link 402 via a user input device or a control device (e.g., an input/output device 720 or a control device 722 in FIG. 7). The summary preview can be displayed on the user interface 400 in response to a user moving a cursor to be positioned overlapping with the link 402 or to a position that is within a threshold limit from an edge of the link 402 (e.g., the user is hovering the cursor over or in the vicinity of the link 402). Alternatively, an input from a user can include a click, a drag, a tap, a double click, or a combination thereof provided via a user input device or a control device when a cursor or a caret is positioned within the threshold distance from the link 402. The summary preview 404 can be positioned adjacent to the link 402 and can overlap with the content block 414 on the page 408, as shown.

The summary preview 404 includes a textual summary of the content of a page 416 shown in FIG. 4B associated with the link. The pages 408 and 416 are pages of the same workspace. In particular, the textual summary of the summary preview 404 is a summary that is included on in a summary block 424 on the page 416 and includes a summary that represents a summary of the content of the page 416. The page 416 can be displayed on the user interface 400 in response to a user input (e.g., a click) when the cursor 410 is positioned on the link 402. In addition to the summary block 424, the page 416 includes an image object 418 (e.g., a picture, symbol, or an icon), a title block 420, a subtitle block 422, and a content block 426.

In some implementations, the summary block 424 is an AI block. An AI block is a prompt block that enables a user to provide instructions (e.g., prompts) to an AI system to perform actions. An AI block can, however, include or be associated with predefined instructions that cause the AI system to perform a particular action. For example, the summary block can be associated with predefined instructions that can initiate processes to create AI generative content of a particular type based on existing content on the page. The existing content can include all or a portion of the content included on the page 416 concurrently with the summary block 424. In some implementations, the existing content can also include content that is external to the page 416. In some implementations, the AI block can include AI blocks described in the U.S. patent application Ser. No. 18/408,429, titled “Providing Generative Artificial Intelligence (AI) Content Based on Existing In-page Content in a Workspace,” filed Jan. 9, 2024, the content of which is herein incorporated by reference in its entirety.

In some implementations, the summary block 424 is displayed on the page 416 as part of a predefined template (e.g., any of the templates 108, 110, 112, and 114 described with respect to FIG. 1). In some implementations, the summary block 424 is displayed on the page 416 in response to an input from a user (e.g., an input as described before). For example, a user can provide an input when a cursor is positioned at a location on the page and the AI block is displayed at that location in response to the input. The input can also include text input (numbers, letters, characters, etc.) or a return key input provided via a keyboard. In some implementations, the text input can be on a text field displayed on the page 416.

The process to create generative summary can be initiated by a user input on the summary block 424. For example, the summary block 424 includes one or more control elements. A control item refers to a visual element on a graphical user interface that is associated with a particular action or interaction performed in response to receiving an input on the control item. In some implementations, a control item is selectable so that a user can provide an input (e.g., a click input) to select to perform the action associated with the control item. In some implementations, a control item includes a text field that allows a user to input text inside the control item. For example, a user provides an input when a cursor is positioned on a control item to initiate an action associated with the summary block 424 in accordance with instructions associated with the summary block 424. Alternatively, the summary block 424 is generated automatically when the page 416 is generated. The process of creating a generative summary can include sending instructions to generate a summary of a particular type to a remote AI system (e.g., via the API 128 described with respect to FIG. 1). The process also includes sending a copy of the content displayed on the page 416 to the AI system and receiving from the AI system generative content to be displayed on the page 416. The textual summary shown in the block 424 can be a summary of the text displayed on the page 416, such as the text displayed in the blocks 420, 422, 426, and/or content from an external source (e.g., accessed via a link included on the page 416). In some implementations, the instructions associated with the summary block 422 define the content to be used for generating the generative content (e.g., the summary is based on only some content on the page 416). As such, the summary can be based on in-page content that is inside the page but not necessarily inside of any block.

The summary preview 404 on page 408 in FIG. 4A can be displayed in response to a determination that the page 416 associated with the link 402 includes the summary block 424. The textual summary in the summary block 424 is generated by the AI server system prior to providing the link to the page 416 on the page 408 and is then stored as a property of the page 416. For example, textual summary of the summary block 424 is stored as a summary property for a page-type block corresponding to the page 416. The storing can include storing the summary property to a cache record of the workspace. The textual summary can be then retrieved from the cache record and displayed on the page 408 in response to the input from the user.

FIG. 4C includes the user interface 400 with the page 408. In FIG. 4C, the content block 414 includes a link 430 and a glimpse preview 428. The link 430 is associated with a page 432 shown in FIG. 4D. The FIG. 4D does not include a summary block, as was the case with the page 416 in FIG. 4B. Instead, page 432 includes a title block 434, and multiple content blocks (e.g., content blocks 436, 438, and 440). In an instance that the page 432 associated with the link 430 does not include a summary block, the preview displayed in response to a user input on the link 430 is the glimpse preview 428 instead of a summary preview. The glimpse preview 428 includes representations of blocks (e.g., a subset of blocks) preselected from the multiple content blocks of the page 432. In some implementations, the preselected blocks include a predefined number of content blocks (e.g., two, three, four, five, or six) of the page 432. The preselected blocks can be selected based on their location (e.g., a predefined number of blocks located nearest a top edge of the page 432). In some implementations, the preselected blocks are selected based on the content (e.g., a title, a subtitle, text content, or image content). In some instances, the title block is always included in the preselected blocks. In some instances, a block with the most text content is included in the preselected blocks. The preselection can be performed prior to generating the link 430 on the page 408 in FIG. 4C. The information regarding the preselection can be included as a page property in cache records associated with the workspace. The glimpse preview 428 is configured to provide an informative preview of the content of the page 432 in instances where the summary block including the AI-generated textual summary of the content of the page is not available, as described with respect to FIGS. 4A and 4B. In some implementations, summary blocks and the preselection of blocks for a glimpse preview is done in real-time (e.g., in response to generating an associated link).

In some embodiments, the summary preview 404 and the glimpse preview 428 can include, in addition to the content described before, metadata associated with the respective pages 416 and 432. The metadata can include information or descriptive details about the data associated with the page and/or the workspace (e.g., information about pages, files, documents, projects, or any other items stored or organized within the workspace). Metadata can include, for example, a title, a name of the creator of the content, a name of an organization associated with the content, date of creation, last date of being reviewed or modified, location of the content, owner of the content, descriptive information, administrative information etc.

In some embodiments, the summary preview 404 and the glimpse preview 428 can be modified in response to modifications on the respective pages 416 and 432. In the instance of the summary preview 404, when the textual summary in the summary block 424 is modified, the modified textual summary is stored as a property of the page 416. Thus, the summary preview 404 that is retrieved as a property of the page 416 will include the modified textual summary. The textual summary in the summary block 424 can be caused to be modified (regenerated) by the generative AI system automatically in response to a modification to the content of the page or in response to a user input that requests for the modified textual summary. Similarly in the instance of the glimpse preview 428, the preselected blocks to be included in the glimpse preview and/or content included inside the preselected blocks can be modified in response to modifications on the page 432. For example, if a block that was part of the preselected blocks for the glimpse preview was removed, the block representation is removed from the glimpse preview. Similarly, new blocks can be added, content can be modified, etc., based on modifications on the page 432. In some implementations, the modifications described herein can be done in real time. For example, while a first user is reviewing page 416 or 432 and the respective preview 404 or 428 is being displayed, another user may modify the content on the respective page 416 or 432. In response to the modification, the associated preview can be modified in real time while continuously displaying the preview. In some implementations, the previews are modified only at the time of initiating the display of the preview in response to the user input.

FIG. 4E illustrates a preview indication 441 configured to indicate that a preview for the content of the associated link is being retrieved. For example, in response to the user input to initiate preview of the link content, while the glimpse preview 428 and/or the summary preview 404 is loading, the page 408 can display the preview indication 441 to indicate to the user that a preview is being loaded.

FIG. 4F includes the user interface 400 with the page 408 including a link 442 and a glimpse preview 444. The link 442 is associated with a page 448 shown in FIG. 4G. The page 448 does not include a summary block. Instead, page 448 includes a content block 450 and a cover image block 446. The cover image block 446 includes an image object that is selected to represent the content of the page 448. In some implementations, the image object in the cover image block 446 is selected by a user (e.g., a user who generated the page 448). In some implementations, the image object is selected by an AI server (e.g., based on the text content of the page). For example, the content block 450 includes a story about a Samoyed dog named Samosa and the cover image block 446 includes a picture of a Samoyed dog. The glimpse preview 444 including representations of the blocks (e.g., a subset of blocks) preselected from blocks of the page 448 include a representation of the cover image block (e.g., an image 445 including the picture of the Samoyed dog). For example, in response to a determination that the page 448 does not include a summary block but includes a cover image block (e.g., the cover image block 446), the glimpse preview 444 is preselected to include a representation of the cover image block.

In some implementations, a glimpse preview or a summary preview can be displayed on a windowpane (e.g., a side panel) of the user interface 400. FIG. 4H includes the user interface 400 with page including a content search page 452. The content search page 452 includes a control item (e.g., a search bar 454) for receiving a user input (e.g., a textual user input). A control item refers to a visual element on a graphical user interface that is associated with a particular action or interaction performed in response to receiving an input on the control item. In some implementations, a control item is selectable so that a user can provide an input (e.g., a click input) to select to perform the action associated with the control item. In some implementations, a control item includes a text field that allows a user to input text inside the control item. For example, a user provides an input when a cursor is positioned on the search bar 454 to initiate a query. The input can include a search query (e.g., a keyword or a string of words). In response to the input, the user interface 400 displays a list of search results including search results associated with links 442 and 456. Each of the links is associated with a page of the workspace that includes content relevant to the search query. A user can access the pages by a user input on a respective link.

As described with respect to FIGS. 4A, 4C, and 4E, a preview will be displayed in response to a user input (e.g., hovering) when the cursor 410 is positioned within a threshold distance of each of the links 442 and 456. In FIG. 4H, the cursor 410 is positioned over the link 442 and, in response to the user input, the glimpse preview 444 including the cover image block 446 is displayed on a windowpane 460 (e.g., a sidebar) that is distinct from the search page 452. The windowpane 460 can provide a convenient manner for a user to view a preview while concurrently being able to view the list of search results on the content search page 452. However, such windowpane location for displaying summary and glimpse previews can be used in combination with other types of pages as well (e.g., the page 408).

In some implementations, preselecting the blocks of a page to be included in the glimpse preview is performed based on content included in the blocks. Preselecting a cover image block described with respect to FIGS. 4F and 4G is one example of a preselection based on the content. The preselection can also be done based on links included in the blocks of the associated page, as will be described with respect to FIGS. 41 and 4J. For example, a page of the workspace including multiple blocks can include link blocks and content blocks that include links.

Link blocks (e.g., a link block 474 on a page 472 in FIG. 4J) are in-page objects that are linked to another content on the workspace. A link block occupies a block area on the page it is located at and can be moved around within a page as any other block on the page. An example of a link block is a synchronized block that is a block that is shared on multiple pages of the workspace. A synchronized block is automatically updated across the multiple pages when a change is made at a synchronized block on a particular page. As another example, the page of the workspace including the multiple blocks can include content blocks that include embedded links. For example, FIG. 4J includes a content block 476 on the page 472 including text content 468 and embedded links 466). In some implementations, preselecting the blocks to be included in a glimpse preview of a link associated with the page 472 (e.g., a glimpse preview 464 of a link 462) includes selecting the content block 476 including the embedded links 466 and the text content 468 while excluding the link block 474. In particular, even though both of the blocks are located nearest to a top edge of the page 472 and would be preselected to be represented on the glimpse preview, the link block 474 is excluded from the selection due to the features associated with the link block 474.

FIG. 4K illustrates the user interface 400 including the page 408 with a link 478 providing access to content that is outside the workspace (e.g., the content is from a third-party provider or from the internet). The link can be connected to the content outside the workspace via a URL. In such instances, in response to an input when the cursor 410 is moved within the threshold distance of the edge of the link 478, the page 408 includes a preview 480 associated with the content outside of the workspace. The preview 480 can include information retrieved from metadata associated with the content. The preview 480 can include, for example, a title, a name of the creator of the content, a name of an organization associated with the content, a date of creation, a last date of being reviewed or modified, a location of the content, an owner of the content, descriptive information, administrative information, etc.

FIG. 4L illustrates the user interface 400 including the page 408 with a link 484 to an empty page of the workspace. In such instances, a preview 482 associated with the link 484 can display only a location of the empty page within the workspace (e.g., “Company OS/Tasks”). In some implementations, the preview 482 can include metadata associated with the empty page, as described above. In some implementations, the preview 482 can also include an indication that the associated page includes no content (e.g., by displaying a notification “No content available”).

FIG. 4M illustrates the user interface 400 including the page 408 with a link that the user viewing the page 408 has no permission to access. As described with respect to the block data model and the hierarchical organizational blocks, the blocks (e.g., pages) of the workspace can be associated with access permissions that define which users have a permission to review (e.g., access) the content on the blocks. In accordance with a determination that the user does not have permission to review the content associated with a link, an indication (e.g., an indication 486) of the lack of permission can be displayed. In some implementations, the determination of the permission to access is performed by the server of the workspace when the user, for example, opens the page including the link. In such implementations, the indication 486 can be displayed instead of displaying the link. In some embodiments, the determination of the permission to access is performed by the server of the workspace when the user is providing an input on the link either to open the link or to review the preview associated with the link. In such implementations, the indication 486 can be displayed as a link preview.

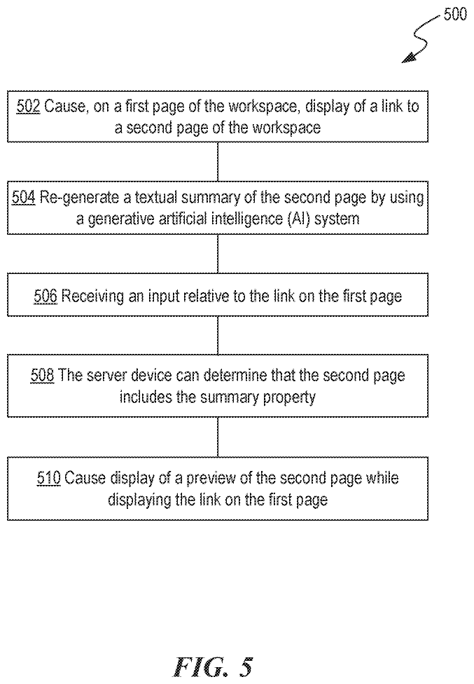

FIG. 5 is a flow diagram illustrating processes 500 for providing a link and associated preview of a summary of content on a workspace. The processes 500 can be performed by an electronic server device or a system (e.g., the computer system 700 described with respect to FIG. 7). The processes 500 can include displaying a graphical user interface such as the user interface 400 described with respect to FIGS. 4A through 4M, which is associated with a workspace.

At 502, the server device can cause, on a first page of the workspace (e.g., the page 408 in FIG. 4A), display of a link to a second page of the workspace (e.g., the link 402 in FIG. 4A to the page 416 in FIG. 4B). The first and second pages can be blocks of the workspace. The link can be embedded as an in-page object on the first page. For example, the link 402 is embedded as an in-page object in the content block 414 on page 408. The content block 414 can include other content as well, such as textual content, image objects, and/or other links. The second page can embed multiple blocks as in-page objects. Each block can include multiple properties that are defined by a block type of the respective block. For example, page 416 includes the title block 420, the subtitle block 422, the summary block 424, and the content block 426 in FIG. 4B.

At 504, the server device can regenerate a textual summary of the second page by using a generative AI system. The textual summary can be regenerated prior to runtime of the display of the link to the second page in the first page. The textual summary can be stored as a summary property for a page-type block corresponding to the second page. For example, the summary block 424 is an AI block that includes, or is associated with, predefined instructions that can initiate processes to create AI generative textual summary based on some or all of existing content on the page 416 (e.g., content on the page 416 that is outside the summary block 424).

In some implementations, pregenerating the textual summary of the second page includes receiving an input that actuates a control of a block configured to initiate a generative process to create the textual summary. For example, a user can provide an input or a combination of inputs to add a prompt block on the page 416 to activate an existing prompt block that is associated with the instructions to cause the AI system to generate the textual summary. The pregenerating can include determining a selection of in-page content based on a location of the block relative to the in-page content. The selection can include all of the content on the page 416 or some of the content on the page 416. In some implementations, the selection includes title blocks and/or content blocks that are adjacent to the summary block 424 or that are positioned between the summary block 424 and a top edge of the page 416. The pregenerating can include causing the AI system to create a textual summary based on the selection of the in-page content. For example, causing the generative AI system to create the textual summary can include sending the AI system instructions to create the summary based on a particular text as well as sending a copy of that text to the AI system. The pregenerating can also include populating the block to present the textual summary. For example, in FIG. 4B, the block 424 is populated to present the textual summary generated by the AI system.

In some implementations, determining the selection of in-page content based on the location of the block relative to the in-page content includes selecting a portion of the in-page content bounded by the location of the block and a top or bottom of the page of the workspace. For example, the selection includes title blocks and/or content blocks that are positioned between the summary block 424 and a top edge of the page 416 (e.g., title block 420, subtitle block 422, and the content block 426). As another example, the selection includes title blocks and/or content blocks that are positioned adjacent to the summary block 424. In some implementations, determining the selection of in-page content based on the location of the block relative to the in-page content includes selecting an entirety of the in-page content bounded by the page of the workspace (e.g., entirety of the in-page content on the page 416 that is outside the summary block 424).

In some implementations, the method includes detecting a change to in-page content of the second page (e.g., a modification is detected to title block 420, subtitle block 422, and/or content block 426). In response to detecting the change to the in-page content, the method can include automatically causing the generative AI system to regenerate the textual summary (e.g., the textual summary in the summary block 424 is regenerated in accordance with the modified content). The method can include storing the regenerated textual summary as the property for the page-type block.

At 506, the server device can receive an input relative to the link on the first page. The input can include moving a cursor (e.g., the cursor 410) to a location that is within a threshold distance from the link (e.g., the link 402). In some implementations, the input relative to the link on the first page includes moving a cursor to a location that is within a threshold distance from an edge of the link.

At 508, the server device can determine that the second page includes the summary property. In response to determining that the second page includes the summary property, at 510 the server device can cause display of a preview of the second page while displaying the link on the first page. The preview can include the textual summary of the second page that was generated using the generative AI system.

In some implementations, the server device can retrieve the textual summary of the second page from a cache record associated with the workspace in response to the determination that the second page includes the summary property. For example, subsequent to the textual summary being generated by the AI system, the server device stores the textual summary as a property of the page 416 in the cache record associated with the workspace. The textual summary can be retrieved from the cache record in response to receiving the input on the link 402 to display the summary preview 404.

In some implementations, while displaying the preview and in response to a modification to the textual summary property on the second page, the server device can cause display of a modified preview on the first page that is different from the preview. The modified preview can include the modification to the textual summary on the second page. For example, whenever the textual summary in summary block 424 is regenerated, the textual summary is stored in the cache record as a property of the page 416. The regenerated textual summary can be retrieved from the cache record accordingly.

In some implementations, the server device can cause the generative AI system to create a modified textual summary of the second page in response to an additional input on the second page that modifies content of the second page. For example, a user adds content on the page 416, removes content from the page 416, or modifies existing content on the page 416. The server device can store the modified textual summary as a property of the second page. The server device can modify the display of the preview of the second page to include the modified textual summary. In some implementations, the modified textual summary can be displayed on the summary preview 404 in real time.

In some implementations, the preview includes metadata of the second page. The metadata can include a title of the second page and a location of the second page in the workspace. For example, the summary preview 404 includes a title of the page 416 (e.g., “RFC: First-party Notion Links”) and a location of the page 416 (e.g., “Company OS/Docs”).

In some implementations, the server device can display the second page while forgoing displaying the first page in response to an additional input on the link on the first page. For example, in response to an input on the link 402 (e.g., a click) on the page 408 in FIG. 4A, the user interface 400 displays the page 416 in FIG. 4B.

In some implementations, the server device can cause display of a link to a third page of the workspace on the first page of the workspace. In response to a determination that the third page does not include a textual summary in a preview property of the third page, the server device can cause display of the preview to include default metadata of the third page. For example, in an instance that the link is connected with a content that is outside the workspace (e.g., the link 478 in FIG. 4K), the preview includes metadata associated with that content (e.g., the preview 480). Similarly, in an instance that the link is connected with a page of the workspace that is empty (e.g., link 484 in FIG. 4L), the preview includes metadata associated with the empty page (e.g., the preview 482).

In some implementations, in response to a determination that the second page does not include the summary property, the server device can determine whether the second page includes an image object designated as a graphical representation of content of the second page (e.g., the cover image block 446 on page 448 in FIG. 4G). In response to a determination that the second page includes the image object, the server device can display an image block including the image object designated as a graphical representation of the content of the second page concurrently with displaying of the link (e.g., the glimpse preview 444 in FIG. 4F includes the image 445 that is a representation of the cover image block 446 in FIG. 4G).

In some implementations, server device can provide an additional link on the first page of the workspace. The additional link can include a URL linked to content located outside the workspace (e.g., the link 478 in FIG. 4K). In response to an additional input on the additional link, the method can include providing a preview (e.g., the preview 480) of the content located outside the workspace. The preview can include metadata associated with the content.

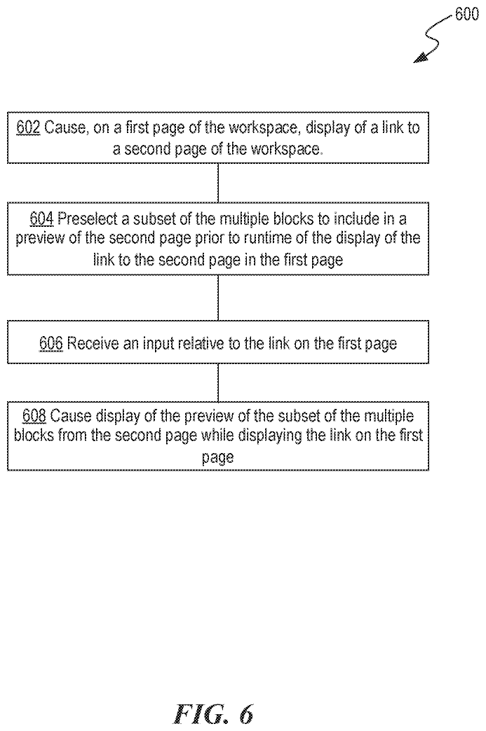

FIG. 6 is a flow diagram illustrating processes 600 for providing a link and associated preview glimpse of content on a workspace. The processes 600 can be performed by an electronic server device or a system (e.g., the computer system 700 described with respect to FIG. 7). The processes 600 can include displaying a graphical user interface such as the user interface 400 described with respect to FIGS. 4A through 4M, which is associated with a workspace.

At 602, the server device can cause, on a first page of the workspace (e.g., link 430 on the page 408 in FIG. 4C), display of a link to a second page of the workspace (e.g., the page 432). The first and second pages can be blocks of the workspace. The link can be embedded as an in-page object on the first page. The second page can embed multiple blocks as in-page objects. Each block can have multiple properties that are defined by a block type of the respective block.

At 604, the server device can preselect a subset of the multiple blocks (e.g., blocks 434, 436, 438, and 440 on the page 432 in FIG. 4D) to include in a preview of the second page prior to runtime of the display of the link to the second page in the first page. The subset of the multiple blocks can be less than an entirety of the multiple blocks of the second page. The subset of the multiple blocks can be preselected from among the multiple blocks based on content of a respective block or a location of the respective block on the second page.

In some implementations, preselecting the subset of the multiple blocks to include in the preview of the second page includes selecting a predefined number of blocks (e.g., two, three, four, five, or six) on the second page on a predefined location of the second page (e.g., nearest to a top edge of the page 432 in FIG. 4D).

In some implementations, preselecting the subset of the multiple blocks to include in the preview of the second page includes adding content to the preview of the second page from a source that is external to the workspace. The content can be linked to the second page via a URL in one of the blocks of the subset of the multiple blocks. For example, in FIG. 4J the content block 476 includes embedded links 466. In an instance that the link is associated with content that is external to the workspace, the server device can retrieve the content external to the workspace based on the link and include such content in the preview (e.g., the preview 464 in FIG. 4I).

In some implementations, preselecting the subset of the multiple blocks to include in the preview of the second page includes determining that a particular block of the multiple blocks is an in-page object associated with a link to a source external to the second page (e.g., the link block 474 in FIG. 4J). In response to determining that the particular block is the in-page object associated with the link to the source external to the workspace, the server device can exclude the particular block from the subset of the multiple blocks. For example, the glimpse preview 464 in FIG. 4I does not include content from the link block 474. Instead, the glimpse preview 464 includes content from the content block 476 in FIG. 4J.

In some implementations, preselecting the subset of the multiple blocks to include in the preview of the second page includes selecting a particular block of the multiple blocks including text content and a particular link including a URL linked to content located outside the particular block. The preselecting can include adding the particular block and the particular link to the preview of the second page. For example, the content block 476 in FIG. 4J includes text content 468 and embedded links 466. The glimpse preview 464 in FIG. 4I includes the embedded links 466 and the text content 468.

In some implementations, preselecting the subset of the multiple blocks to include in the preview of the second page includes storing the preview as a preview property for a page-type block corresponding to the second page. The preselecting can also include dynamically updating the preview property of the second page on demand or in response to a change to the second page or the multiple blocks.

In some implementations, preselecting the subset of the multiple blocks to include in the preview of the second page includes determining whether the second page includes a block with an image object designated as a graphical representation of content of the second page (e.g., as described with respect to FIGS. 4E and 4F). In response to a determination that the second page includes the block with the image object, the server device can include the block with the image object in the subset of the multiple blocks from the second page.

At 606, the server device can receive an input relative to the link on the first page. The input can include moving a cursor (e.g., the cursor 410 in FIG. 4C) to a location that is within a threshold distance from the link.

In response to the input, at 608, the server device can cause display of the preview of the subset of the multiple blocks from the second page while displaying the link on the first page. In some implementations, displaying the preview of the subset of the multiple blocks includes displaying the preview as a pop-up feature that is positioned adjacent to or partially overlapping the link on the first page (e.g., the glimpse preview 428 associated with the concurrently displayed link 430 in FIG. 4C). In some implementations, displaying the preview of the subset of the multiple blocks includes displaying the preview on a windowpane that is separate from the first page (e.g., the glimpse preview 444 associated with the concurrently displayed link 442 displayed on the windowpane 460 in FIG. 4H).

In some implementations, the server device can determine that a preview property of a page-type block corresponding to the second page does not include a textual summary of content of the second page (e.g., the page 432 in FIG. 4D does not include a summary block as described with respect to FIG. 4B). The determination is performed prior to preselecting the subset of the multiple blocks to include in the preview of the second page.

In some implementations, the server device processes a query for content included the workspace prior to causing display of a link to a second page of the workspace (e.g., a query in response to an input on the search bar 454 on the content search page 452 in FIG. 4H). The server device can cause display of a list of search results that satisfy the query on the first page (e.g., the list of search results including links 456 and the link 442). The link to the second page can be included in the list of search results.

### Computer System

FIG. 7 is a block diagram that illustrates an example of a computer system 700 in which at least some operations described herein can be implemented. As shown, the computer system 700 can include: one or more processors 702, main memory 706, non-volatile memory 710, a network interface device 712, a display device 718, an input/output device 720, a control device 722 (e.g., keyboard and pointing device), a drive unit 724 that includes a machine-readable (storage) medium 726, and a signal generation device 730 that are communicatively connected to a bus 716. The bus 716 represents one or more physical buses and/or point-to-point connections that are connected by appropriate bridges, adapters, or controllers. Various common components (e.g., cache memory) are omitted from FIG. 7 for brevity. Instead, the computer system 700 is intended to illustrate a hardware device on which components illustrated or described relative to the examples of the figures and any other components described in this specification can be implemented.

The computer system 700 can take any suitable physical form. For example, the computer system 700 can share a similar architecture as that of a server computer, personal computer (PC), tablet computer, mobile telephone, wearable electronic device, network-connected (“smart”) device (e.g., a television or home assistant device), augmented reality/virtual reality (AR/VR) system (e.g., head-mounted display), or any electronic device capable of executing a set of instructions that specify action(s) to be taken by the computer system 700. In some implementations, the computer system 700 can be an embedded computer system, a system-on-chip (SOC), a single-board computer (SBC) system, or a distributed system such as a mesh of computer systems or include one or more cloud components in one or more networks. Where appropriate, one or more computer systems 700 can perform operations in real time, near real time, or in batch mode.

The network interface device 712 enables the computer system 700 to mediate data in a network 714 with an entity that is external to the computer system 700 through any communication protocol supported by the computer system 700 and the external entity. Examples of the network interface device 712 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 706, non-volatile memory 710, machine-readable (storage) medium 726) can be local, remote, or distributed. Although shown as a single medium, the machine-readable (storage) medium 726 can include multiple media (e.g., a centralized/distributed database and/or associated caches and servers) that store one or more sets of instructions 728. The machine-readable (storage) medium 726 can include any medium that is capable of storing, encoding, or carrying a set of instructions for execution by the computer system 700. The machine-readable (storage) medium 726 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 710, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 704, 708, 728) set at various times in various memory and storage devices in computing device(s). When read and executed by the processor 702, the instruction(s) cause the computer system 700 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but no other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the Detailed Description above using the singular or plural number may also include the plural or singular number respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the Detailed Description above explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a mean-plus-function claim will use the words “means for.” However, the use of the term “for” in any other context is not intended to invoke a similar interpretation. The applicant reserves the right to pursue such additional claim forms in either this application or in a continuing application.

I/We claim:

1. A computer-implemented method for providing a link and associated preview of content on a workspace, the method comprising:
causing, on a first page of the workspace, display of a link to a second page of the workspace,
wherein the first and second pages are blocks of the workspace, the link is embedded as an in-page object on the first page, and the second page embeds multiple blocks as in-page objects, and
wherein each block has multiple properties that are defined by a block type of the respective block;
preselecting, prior to runtime of the display of the link to the second page in the first page, a subset of the multiple blocks to include in a preview of the second page,
wherein the subset of the multiple blocks is less than an entirety of the multiple blocks of the second page, and
wherein the subset of the multiple blocks is preselected from among the multiple blocks based on content of a respective block or a location of the respective block on the second page;
receiving an input relative to the link on the first page,
wherein the input incudes moving a cursor to a location that is within a threshold distance from the link; and
in response to the input,
causing, while displaying the link on the first page, display of the preview of the subset of the multiple blocks from the second page.

2. The method of claim 1, wherein preselecting the subset of the multiple blocks to include in the preview of the second page comprises:
selecting a predefined number of blocks on the second page on a predefined location of the second page.

3. The method of claim 1, wherein preselecting the subset of the multiple blocks to include in the preview of the second page comprises:
adding content to the preview of the second page from a source that is external to the workspace,
wherein the content is linked to the second page via a Uniform Resource Locator (URL) in one of the blocks of the subset of the multiple blocks.

4. The method of claim 1, wherein preselecting the subset of the multiple blocks to include in the preview of the second page comprises:
determining that a particular block of the multiple blocks is an in-page object associated with a link to a source external to the second page; and
in response to determining that the particular block is the in-page object associated with the link to the source external to the workspace, excluding the particular block from the subset of the multiple blocks.

5. The method of claim 1, wherein preselecting the subset of the multiple blocks to include in the preview of the second page comprises:
selecting a particular block of the multiple blocks including text content and a particular link comprising a Uniform Resource Locator (URL) linked to content located outside the particular block; and
adding the particular block and the particular link to the preview of the second page.

6. The method of claim 1, wherein preselecting the subset of the multiple blocks to include in the preview of the second page comprises:
storing the preview as a preview property for a page-type block corresponding to the second page; and
dynamically updating the preview property of the second page on demand or in response to a change to the second page or the multiple blocks.

7. The method of claim 1, further comprising, prior to preselecting the subset of the multiple blocks to include in the preview of the second page:
determining that a preview property of a page-type block corresponding to the second page does not include a textual summary of content of the second page.

8. The method of claim 1, prior to causing display of a link to a second page of the workspace:
processing a query for content included the workspace; and
causing display of a list of search results that satisfy the query on the first page, wherein the link to the second page is included in the list of search results.

9. The method of claim 1, wherein preselecting the subset of the multiple blocks to include in the preview of the second page comprises:
determining whether the second page includes a block with an image object designated as a graphical representation of content of the second page; and
in response to a determination that the second page includes the block with the image object,
including the block with the image object in the subset of the multiple blocks from the second page.

10. The method of claim 1, wherein displaying the preview of the subset of the multiple blocks comprises:
displaying the preview as a pop-up feature that is positioned adjacent to or partially overlapping the link on the first page.

11. The method of claim 1, wherein displaying the preview of the subset of the multiple blocks comprises:
displaying the preview on a windowpane that is separate from the first page.

12. An electronic server device for providing a link and associated preview of content on a workspace, the server device comprising:
at least one hardware processor; and
at least one non-transitory memory storing instructions, which, when executed by the at least one hardware processor, cause the server device to:
cause, on a first page of the workspace, display of a link to a second page of the workspace,
wherein the second page embeds multiple blocks as in-page objects;
preselect, prior to runtime of the display of the link to the second page in the first page, a subset of the multiple blocks to include in a preview of the second page,
wherein the subset of the multiple blocks is preselected from among the multiple blocks based on content of a respective block or a location of the respective block on the second page; and
in response to an input relative to the link on the first page,
cause, while displaying the link on the first page, display of the preview of the subset of the multiple blocks from the second page.

13. The server device of claim 12, wherein preselecting the subset of the multiple blocks to include in the preview of the second page comprises:
selecting a predefined number of blocks on the second page on a predefined location of the second page.

14. The server device of claim 12, wherein preselecting the subset of the multiple blocks to include in the preview of the second page comprises:
adding content to the preview of the second page from a source that is external to the workspace,
wherein the content is linked to the second page via a Uniform Resource Locator (URL) in one of the blocks in the subset of the multiple blocks.

15. The server device of claim 12, wherein preselecting the subset of the multiple blocks to include in the preview of the second page comprises:
determining that a particular block of the multiple blocks is associated with a link to a source external to the workspace; and
in response to determining that the particular block is associated with the link to the source external to the workspace, excluding the particular block from the subset of the multiple blocks.

16. The server device of claim 12, wherein preselecting the subset of the multiple blocks to include in the preview of the second page comprises:
storing the preview as a preview property for a page-type block corresponding to the second page; and
dynamically updating the preview property of the second page on demand or in response to a change to the second page or the multiple blocks.

17. A non-transitory, computer-readable storage medium comprising instructions recorded thereon, wherein the instructions, when executed by at least one data processor of a system, cause the system to perform a function on a workspace that includes multiple pages, the processor being caused to:
cause, on a first page of the workspace, display of a link to a second page of the workspace,
wherein the second page embeds multiple blocks as in-page objects;
preselect, prior to runtime of the display of the link to the second page in the first page, a subset of the multiple blocks to include in a preview of the second page,
wherein the subset of the multiple blocks is preselected from among the multiple blocks based on content of a respective block or a location of the respective block on the second page; and
in response to an input relative to the link on the first page,
cause, while displaying the link on the first page, display of the preview of the subset of the multiple blocks from the second page.

18. The computer-readable storage medium of claim 17, wherein
preselecting the subset of the multiple blocks to include in the preview of the second page comprises:
selecting a predefined number of blocks on the second page on a predefined location of the second page.

19. The computer-readable storage medium of claim 17, wherein
preselecting the subset of the multiple blocks to include in the preview of the second page comprises:
adding content to the preview of the second page from a source that is external to the workspace,
wherein the content is linked to the second page via a Uniform Resource Locator (URL) in one of the blocks of the subset of the multiple blocks.

20. The computer-readable storage medium of claim 17, wherein
preselecting the subset of the multiple blocks to include in the preview of the second page comprises:
determining that a particular block of the multiple blocks is associated with a link to a source external to the workspace; and
in response to determining that the particular block is associated with the link to the source external to the workspace, excluding the particular block from the subset of the multiple blocks.
